(19) United States
(12) Patent Application Publication
(10) Pub. No.: US 2006/0105135 A1
(43) Pub. Date: May 18, 2006

(54) Breathable cushion and method of manufacturing the same

(76) Inventors: Chao-Chia Chien, Taichung Hsien (TW); Jung-Chiarn Lee, Taichung Hsien (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/988,676

(22) Filed: Nov. 15, 2004

(51) Int. Cl. B32B 37/00; B32B 3/00

(52) U.S. Cl. 428/73; 156/196; 156/292

(57) ABSTRACT

A method and apparatus is disclosed for making a breathable cushion. The cushion core is prepared by laying down two corrugated web of thermoplastic sheets, selectively welding the node-antinode location, and repeating the process until a cushion core of the desired depth is prepared. The cushion core is thus bonded sheets of material to form the geometry shape cells in structure, such as star shape or hexagon shape cells. The present invention also provides methods for enclosing the cushion core with thermoplastic film. It is not only to improve the bond ability of said thermoplastic cushion core, but to meet the aesthetic requirements. An apparatus for carrying out the method for welding thermoplastic honeycomb structures is also disclosed.

### FIELD OF INVENTION

The present invention relates to a breathable cushion and a method for making the same.

### RELATED PRIOR ART

Foam materials are frequently used as a cushioning material. However, foams are very bulky for the amount of protection provided and yield very easily in the direction of impact. Thus, an effective impact absorbing foam pad must be relatively thick, bulky, relatively inflexible, and difficult to ventilate. An excellent cushion is required to have comfort as well as a function of supporting and holding a weight of a user (e.g., a weight of human body). Specifically, the cushion is required to have appropriate softness, compressibility, high vibration absorption, deformation compliance, and flattening resistance. In the past, Polyurethane foam, rubber foam, synthetic resin foam such as thermoplastic poly elastomer (such as TPE), coil springs, or the like has been used alone or in combination.

Honeycomb structures cushions are widely used in body pads because they are flexible in the directions perpendicular to impact yet rigid in the direction of impact, and are very light in weight and give freedom of movement to the user.

There are a variety of ways to manufacture honeycomb cores. One common method of manufacture is typified by U.S. Pat. No. 3,660,217, issued to Kehr et al. The use of adhesives to bond the honeycomb layers together is relatively simple and is acceptable for many applications. However, a variety of factors may contribute to uneven bonding which often yields less than desirable results.

These protective inserts are typically referred to as “fingers” and are designed to prevent the top two layers which are being welded together from sticking to the remainder of the stack, issued by Huebner, U.S. Pat. No. 4,957,577. This is a time consuming process. The fingers must be removed once the stack is expanded. This can present problems, especially when the lateral dimensions of the honeycomb are large.

The plural aromatic polyimide sheets are combined to each other with a heat resistant adhesive at adhesive regions arranged between the two sheets at equal intervals in order to form Polyimide film honeycomb panels, are described in U.S. Pat. No. 4,921,745. A stack of interconnected thermoplastic layers which is adapted for use in forming a honeycomb structure, are described in U.S. Pat. No. 5,435,273. After the plurality of thermoplastic layers has been interconnected in this manner, the said stack is expanded by pulling in order to form the honeycomb structure. It is a drawback of the known process that it is difficult to apply the appropriate amount of heat to the bonding locations on the second foils so as to achieve the desired melting depth and to prevent the foils from being completely connected to one another

A process for the continuous preparation of honeycomb sandwich materials by adhering one or more skins to a thermoplastic honeycomb core, are described in U.S. Pat. No. 5,316,604. A method for creating a bond enhancement layer for thermoplastic urethane panels is disclosed in U.S. Pat. No. 6,099,680. It is however difficult to ensure the adhesion among the front surface panel, the honeycomb core, and the rear surface panel, particularly along the edges. The surface panel tends to be delaminated from the honeycomb core due to a difference in pressure between the inside and the outside of the honeycomb sandwich panel.

The present invention is intended to overcome the problems encountered in prior art.

### SUMMARY OF THE INVENTION

A plurality of corrugated thermoplastic sheets is prepared. In accordance with the present invention, it was discovered that honeycomb or star-shape structures can be made from corrugated thermoplastic materials. It was discovered that a strong structural weld or fusion bond could be obtained, since only the top two layers are completely melted during the welding operation each time.

The present invention involves a method for forming a geometry cell structure wherein a plurality of thermoplastic layers is welded together at selected locations. The bond portions of each corrugated thermoplastic sheet can be precisely located, and welded together. The melting of the thermoplastic layers during the welding step is controlled by high frequency welding apparatus so that the two layers are welded without sticking the other welded layers. The high frequency welding apparatus is recommended to carry out the welding operation of thermoplastic layers. As a feature of the present invention, low temperature working environment is provided by high frequency welding apparatus which doesn't produce any heat waste after welding. This minimizes heat migration of the melt zone into the underlying layers and prevents undesirable welding of the layers.

A geometry cell structure is characterized in that the chamber between two corrugated sheets is configured as an air chamber, a cushion made of elastomer(or thermoplastic) material, in the form of a layered spring. The present invention is directed to a cushion with thin and vertical diaphragms to be buckled and welded together, which is arranged in a honeycomb, or other geometry structure. The hardness of honeycomb could be adjusted by the density of cells and cell shape. The harder hardness of cushion can be obtained by the higher density of cells.

It has now been discovered that a thermoplastic honeycomb core or other thermoplastic core material may be bonded to facing sheets by the use of a thermoplastic material. The honeycomb core of sandwich panel is not breathable, but the front or rear surface layer or both are porous and breathable. Therefore, the air in the cells can flow freely through the front and rear surface layers. The pressure is balanced between the inside and the outside of the sandwich panel, the front and rear surface layers are prevented from being delaminated or removed from the honeycomb core. High fusion bond of sandwich panel can be obtained also. Furthermore, the sandwich panel can be produced in an economical, continuous manner, since no special process (for example, curing or cooling process) is additionally required. The breathable cushion is flexible, and capable to be molded into various profiles in order to meet user's demand.

The invention defined by the term “cushioning device” includes and is not limited to other products such as chair backs, stadium seat cushions, bicycle seat cushions, automobile seat cushions, saddles, office chairs, lounge chairs, lumbar supports, life jackets, footwear and others. The invention is also useful for cushioning of items other than the human body, such as fragile manufactured goods during shipping.

The above features and advantages of present invention will become apparent, after it is described with the accompanying drawings.

### BRIEF DESCRIPTION OF DRAWINGS

The present invention is introduced by the following embodiment.

FIG. 1 is a flow chart of manufacturing the breathable cushion.

FIG. 2 shows the press mold forming the thermoplastic sheet into desired shape.

FIG. 3 is a lateral picture of two corrugated thermoplastic sheets before welding;

FIG. 4 is a drawing of welding operation by the high frequency welding apparatus.

FIG. 5 is a drawing of cutting the cushion block into desired profile.

FIG. 6 shows an apparatus how to enclose a cushion core with thermoplastic film.

FIG. 7 is a drawing showing how a cushion sandwich panel is shaped by the mold.

FIG. 8 is a perspective view of various cushions in different profile, FIG. 8(a) is an innersole of sneaker; FIG. 8(b) is a seat padding.

FIG. 9 is a side view of a bicycle seat equipped with the breathable cushion shown in FIG. 8.

FIG. 10 is a cutaway view of a sneaker innersole equipped with the breathable cushion.

FIG. 11 is a cutaway view of a sneaker midsole having the moldable cushion to customize the contour of user's foot

FIG. 12 is a perspective view of a cushion core made of square shaped sheets different from the trapezoid shaped sheets in FIG. 5.

### DETAILED DESCRIPTION OF PREFERRED EMBODIMENT

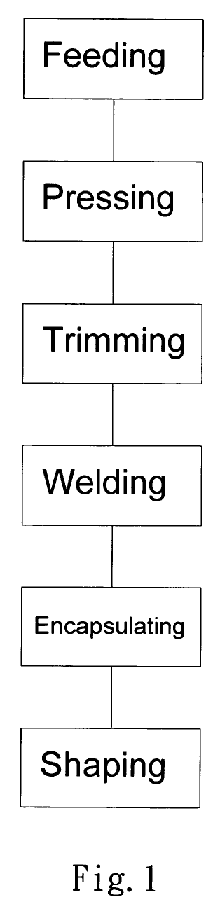

Referring to FIG. 1, a method for making a breathable cushion is according to the preferred embodiment of the present invention.

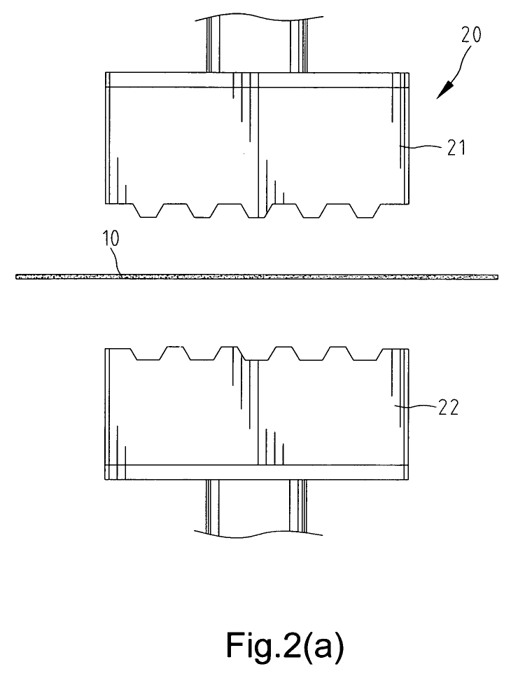

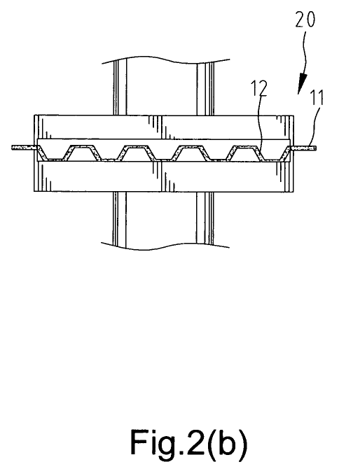

Referring to FIGS. 1 and 2, at step S10, a thermoplastic sheet (10) is fed to a press (20). The corrugated sheets are prepared by the thermoplastic matrix sheets, which may be, for example polyethylene terephthalate(brief as PET) and polybutylene terephthalate; the aliphatic polyamides(e.g., Nylon 6, Nylon 66); polyalkylene polymers(e.g., polypropylene and polyethylene); thermoplastic poly elastomer (brief as TPE); acrylonitrile butadiene styrene, polyether imide, polystyrene, polyvinyl chloride(e.g., PVC), polyacrylate, styrene-butadiene copolymer, ethylene-vinyl acetate copolymer(e.g., EVA), polychloroprene, thermoplastic polyimides or polyurethane(e.g., TPU), and other thermoplastic composite materials. A thermoplastic composite may be any foregoing fabric(e.g., stretchable Lycra, or carbon fiber fabric) dipping with TPU, or polyester fabric dipping with TPE, which are thermoplastic initially, but cure to form cross-linked structures at higher temperatures. However, the substance to be used is not limited thereto.

Referring to FIGS. 2, the press (20) includes an upper mold (21) and a lower mold (22). At step S20, the molds (21) and (22) are closed and heated for a specified period of time. The corrugated sheet (12) is formed by the heated press (20).

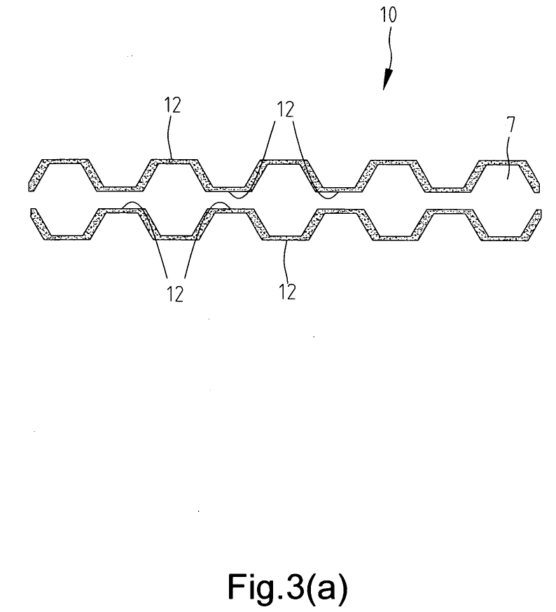

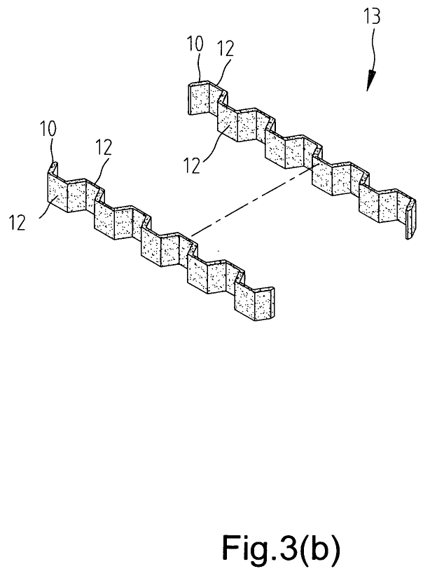

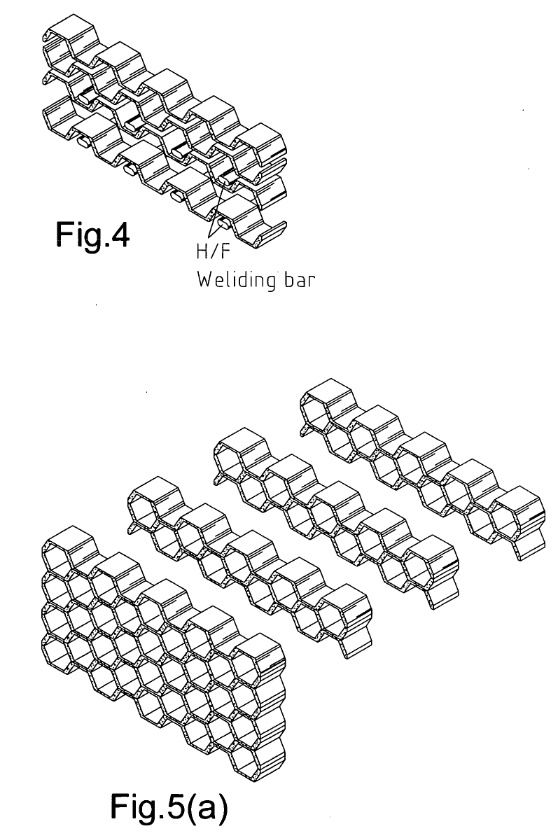

Referring to FIG. 3 and 4, the process for the continuous preparation of thermoplastic cushion core (13) by a high frequency welding apparatus:
a) placing a corrugated sheet into the top welding bar (17);
b) fixing another corrugated sheet into the bottom welding bar (18);
c) activating top and bottom bar with high frequency, substantially coincidently welding the contacting nodes of both corrugated sheets;
d) pulling the bottom bar(18) to the second layer, and placing another corrugated sheet(12) on the top bar(17);
e) activating top and bottom bar with high frequency, substantially coincidently welding the contacting nodes of both shaped thermoplastic sheets;
f) repeating steps a)-e) until a cushion core (13) of the desired depth is obtained.

A high frequency welding apparatus is disclosed in FIG. 4, which provides the controlled melting necessary to carry out the method of the present invention. As a feature of the present invention, low temperature working environment is provided by high frequency welding apparatus which doesn't produce any heat waste after welding. This minimizes heat migration of the melt zone into the welded sheets.

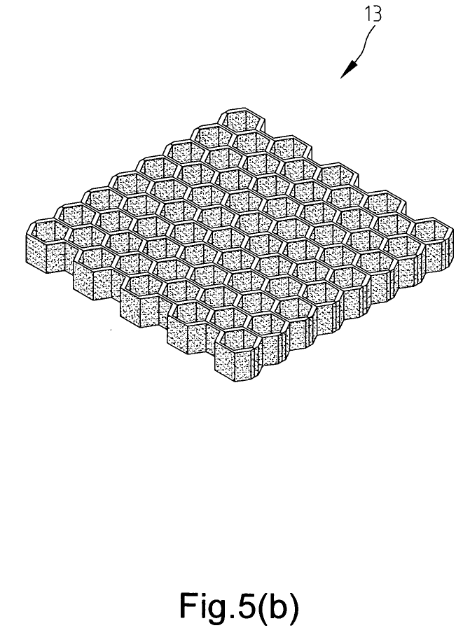

Referring to FIG. 5, the cushion core (13) may be cut into any desirable shape according to various applications.

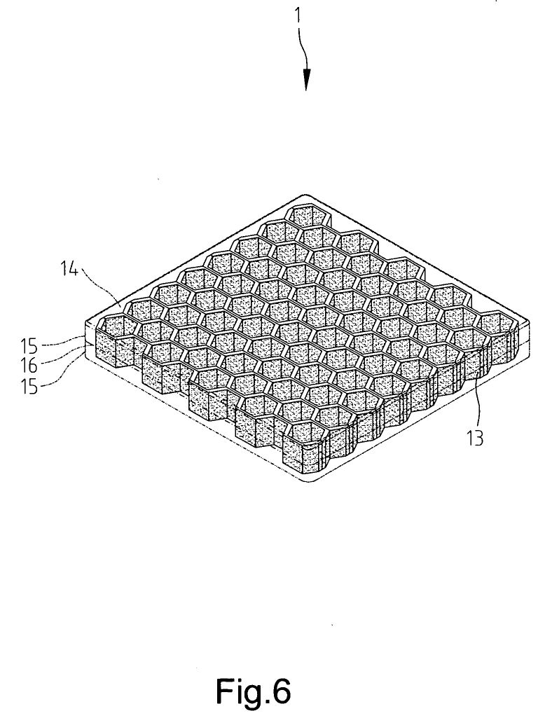

FIG. 6 illustrates an apparatus how to wrap the cushion core with a thermoplastic film. The honeycomb structure (13) is enclosed in an enclosure (14) that may be transparent, translucent or opaque. The enclosure (14) includes two halves (15). Each half (15) including an edge is bonded with the edge of the other half (15). Thus, a breathable honeycomb (1) is encapsulated by two halves(15).

Another way of enclosing the cushion core, that's to heat the front and rear surface thermoplastic films till the curing temperature by the top and bottom heat plate. Then, the cushion core is gently placed in the mold, pressed for a specified period of time. The films or facing sheets can be firmly welded with the cushion core. In order to ensure the bonding quality of assembled sandwich panel, the pressure and operation temperature of plates should be controlled well, so that any residual heat is prevented to overheat and collapse the cushion core.

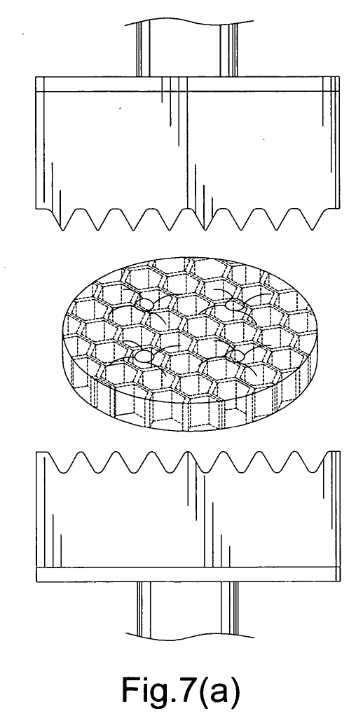

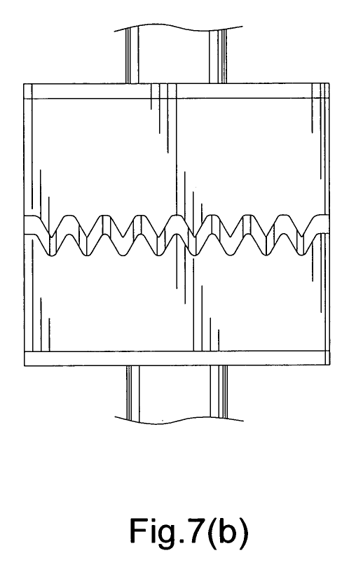

The thermoplastic breathable cushion is capable to be molded into various profiles in order to meet user's demand. FIG. 7 disclose a method of producing a shaped cushion material, comprising the steps of: impregnating a thermoplastic cushion substance in a shape mold; heating and compressing said impregnated base thermoplastic cushion at a softening temperature; cooling down the thermoplastic cushion while retaining the desired shape.

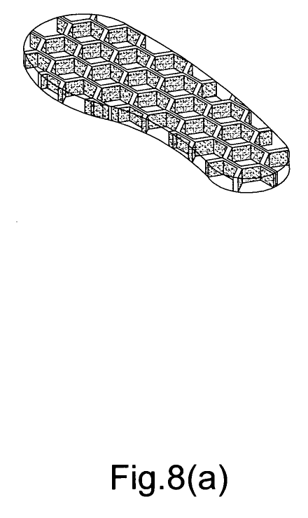

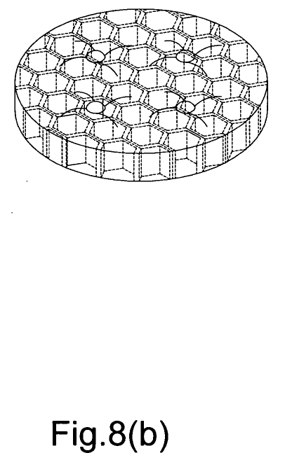

FIG. 8 shows two examples how to apply moldable cushion in seat padding and innersole.

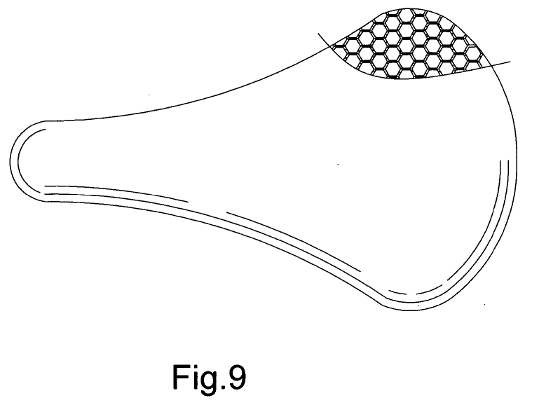

The seat padding of a bicycle is disclosed in FIG. 9, has sufficient cushion ability though it is thin, and is excellent in air permeability.

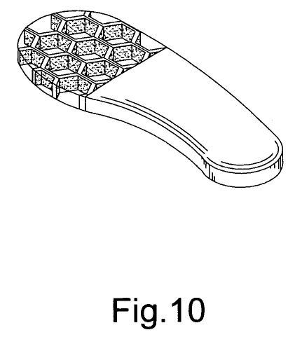

FIG. 10 shows an innersole of a sneaker, which is made by a breathable cushion instead of the conventional EVA foam.

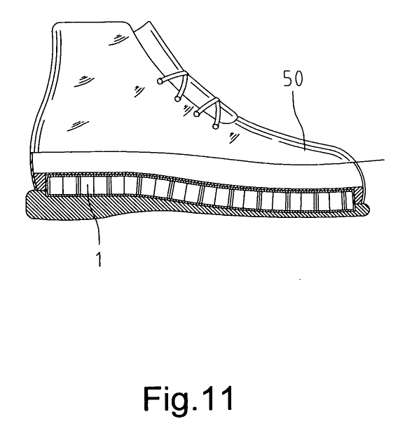

FIG. 11 shows a midsole of a sneaker, that's a breathable cushion shaped or contoured to accommodate the user's foot form in order to cradle the user's heel.

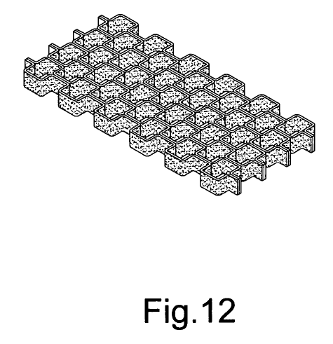

Referring to FIG. 12, a breathable cushion has different geometry cell structure from honeycomb, which cell shape could be rectangular or square.

The present invention has been described via detailed illustration of the preferred embodiment. A lot of alterations and modifications of breathable cushion are anticipated in the future, become apparent to those skilled in the art. It is therefore intended that the following claims be interpreted as covering all such alterations and modifications as fall within the true spirit and scope of the invention.

What is claimed is:

1. a manufacturing method of a breathable cushion with geometry cell structure is claimed as below,
a) Feeding: placing a thermoplastic sheet into the press (20) including top mold (21) and bottom mold (22);
b) Pressing: heating top and bottom mold, and forming the thermoplastic sheet into corrugated shape.
c) Trimming: the redundant portions (11) are exposed out of press mold, and trimmed by the press (20) at the same time.
d) Welding: laying down two corrugated web of thermoplastic sheets, selectively welding the node-antinode location, and repeating the process until a cushion core of the desired depth is prepared. The cushion core is thus bonded sheets of material to form the geometry shape cells in structure, such as star shape or hexagon shape cells.
e) Encapsulating: front and rear surface thermoplastic films are heated to the curing temperature by the top and bottom heat plate, then enclosing the cushion core with thermoplastic films.
f) Shaping: the thermoplastic breathable cushion(1) is capable to be molded into various profiles in order to meet user's demand.

2. The manufacturing method of a breathable cushion with geometry cell structure according to claim 1, wherein the high frequency welding apparatus is recommended to carry out the welding operation of thermoplastic layers.

3. The manufacturing method of a breathable cushion with geometry cell structure according to claim 1, wherein the honeycomb core of sandwich panel is not breathable, but the whole sandwich panel can be breathable owing to the porous or breathable front or rear surface layer.

4. The manufacturing method of a breathable cushion with geometry cell structure according to claim 1, wherein the thermoplastic breathable cushion is capable to be molded into various profiles in order to meet user's demand.

5. The manufacturing method of a breathable cushion with geometry cell structure according to claim 1, wherein a geometry cell structure, characterized in that the chamber (7) between two corrugated sheets (12) is configured as an air chamber, which cell shape, in practice, could be triangular, rectangular, square, pentagonal, hexagonal, heptagonal, octagonal, round, oval, elliptical, egg-shaped, n-sided or any other shape in a cross section decided by the factors of the shape of corrugated sheet and welding locations.

6. A breathable cushion (1) comprising a honeycomb structure (13) and an enclosure (14) for enclosing the honeycomb structure (13).

7. The breathable cushion (1) according to claim 6, wherein the honey comb structure (13) comprises a plurality of thermoplastic corrugated strips (10), each comprising a plurality of bond portions (12) on the face side and a plurality of bond portions (12) on the back side, wherein the bond portions (12) on the face side are bonded with the bond portions (12) on the back side of adjacent corrugated strips (10).

8. The breathable cushion (1) according to claim 6, wherein the cushion enclosure (14) could be sealed by two halves (15), each comprising an edge (16) bonded with the edge (16) of the other half (15).
